(19) United States
(12) Patent Application Publication
(10) Pub. No.: US 2011/0247477 A1
(43) Pub. Date: Oct. 13, 2011

(54) DRUMSTICK

(76) Inventor: Jung-Shih CHANG, Taichung Hsien (TW)

(21) Appl. No.: 12/916,104

(22) Filed: Oct. 29, 2010

(30) Foreign Application Priority Data
Apr. 9, 2010 (TW) 99206316

(51) Int. Cl. G10D 13/02

(52) U.S. Cl. 84/422.4

(57) ABSTRACT

A drumstick comprises an elongated rigid body having a front section, a shaft section and a handle section. The front section is made of wooden or bamboo materials and has a top end and a distal end. A striking tip is mounted on the top end. The handle section is also made of wooden or bamboo materials and has a front end and a butt end. The shaft section is made of composite materials and has a first end, and a second end. The first end of the shaft section is jointed to with the distal end of the front section. The second end of the shaft section is jointed to with the front end of the handle. The shaft section further includes a receiving room defined between the first and second ends for receiving vibration-absorbing devices or weights.

### BACKGROUND OF THE INVENTION

1. Field of the Invention

The present invention relates to percussion instruments, more particularly, to an improved drumstick useable with drums.

2. Description of the Related Art

Traditionally, most drumsticks are made of wood for having acceptable weight, vibration and rigidity. However, wooden drumsticks may splinter, chip, crack or break after a relatively short period of normal use. Specially, when colliding with the metal rim of a drum, for example, when performing “rimshots”, the middle of a drumstick is easily cracked. Furthermore, the center of gravity or “balance point” of a traditional wooden drumstick is not adjustable to produce different sounds.

To solve the drawbacks of the traditional wooden drumsticks, many attempts, such as U.S. Pat. No. 4,047,460, No. 4,384,544, have been made to replace the wood used in traditional drumsticks with various synthetic materials, including composites. However, most composite drumsticks have insufficient rigidity to satisfy typical drummers. Those composite drumsticks that do have a rigidity approaching that of wood are usually quite expensive. The higher cost of composite drumsticks results from the high cost of composite materials such as graphite, which is a highly preferred and often used composite material. Moreover, drumsticks made from graphite composites do not have “wooden feel” and cause to vibrate excessively.

Thus, what is needed is a drumstick with the “wooden feel” but without the disadvantages that a wooden drumstick would have.

### SUMMARY OF THE INVENTION

Accordingly, one of the important objects of the present invention is to provide a drumstick which is cheaper, more durable, more uniform, while retaining a “wooden feel”.

Another object of the invention is to provide a drumstick with desirable vibrations and adjustable “balance point”.

The present invention accordingly provides a drumstick comprising an elongated rigid body having a front section, a shaft section and a handle section. The front section is made of wooden or bamboo materials and has a top end and a distal end. The body of the front section tapers from the distal end to the top end. A striking tip is mounted on the top end. The handle section is also made of wooden or bamboo materials and has a front end and a butt end. The shaft section is made of composite materials and has a first end, and a second end. The first end of the shaft section is jointed to with the distal end of the front section. The second end of the shaft section is jointed to with the front end of the handle. The shaft section further includes a receiving room defined between the first and second ends for receiving vibration-absorbing devices or weights.

In one embodiment, the drumstick of the present invention comprises a front section further having a first rein-forced core member made of a material having a larger rigidity than wood or bamboo.

In another embodiment, the drumstick of the present invention comprises a handle section having a second rein-forced core member made of a material having a larger rigidity than wood or bamboo.

### BRIEF DESCRIPTION OF THE DRAWINGS

The advantages and the features of the present invention will become better understood with reference to the following more detailed description and claims taken in conjunction with the accompanying drawings, in which:

FIG. 1 is a perspective view of a first embodiment of the present invention;

FIG. 2 is a longitudinal cross-sectional view of the drumstick shown in FIG. 1;

FIG. 3 is a longitudinal cross-sectional view of a second embodiment of the present invention;

FIG. 4 is a cross-sectional view of the drumstick shown in FIG. 3, taken along line 4-4 of FIG. 3;

FIG. 5 is a longitudinal cross-sectional view of a third embodiment of the present invention;

FIG. 6 is an enlarged and exploded sectional view of a portion of the drumstick shown in FIG. 5; and

FIG. 7 is a longitudinal cross-sectional view of a fourth embodiment of the present invention.

### DETAILED DESCRIPTION OF THE INVENTION

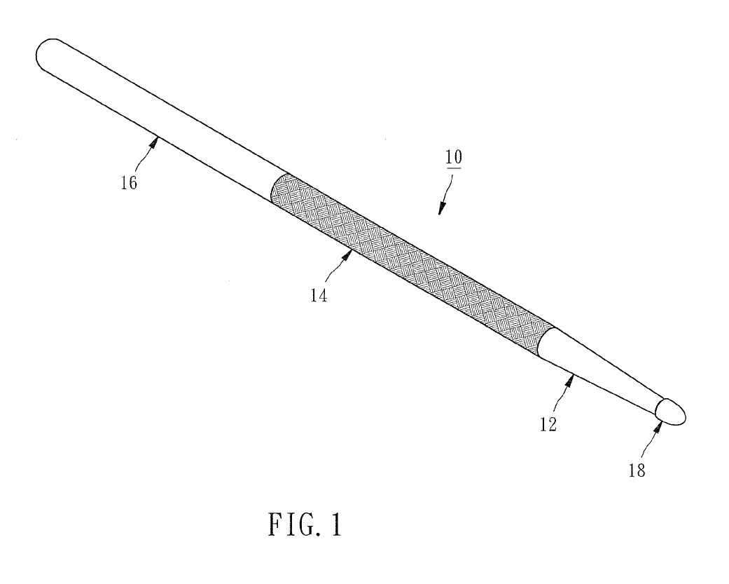

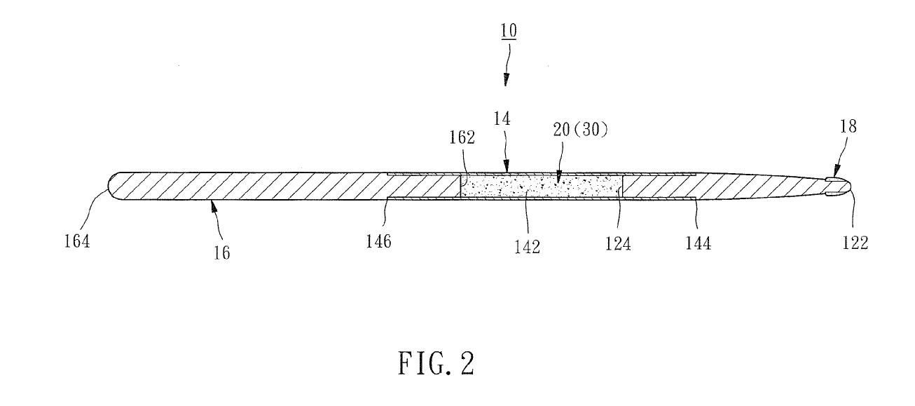

The first embodiment of the drumstick 10 according to the present invention is shown in FIGS. 1 and 2. The drumstick 10 includes a front section 12, a shaft section 14, a handle section 16 and a striking tip 18.

The front section 12 is made of wooden or bamboo materials. It has a top end 122 and a distal end 124. The body of the front section 12 tapers from the distal end 124 to the top end 122. The striking tip 18 is mounted on the top end 122. The striking tip 18 may be made of plastic or composite materials.

The handle section 16 is also made of wooden or bamboo materials. It has a front end 162 and a butt end 164.

The shaft section 14, in this embodiment, is made of graphite composite material. It has a tubular body 142 with a first open end 144 and a second open end 146. In combination, the distal end 124 of the front section 12 and the front end 162 of the handle section 16 are respectively securely inserted into the tubular body 142 from the first open end 144 and the second open end 146 in such a way that a receiving room 20 is defined to receive a vibration-absorbing device 30 (as shown in FIG. 2). The vibration-absorbing device 30 can be made by plastic foam materials.

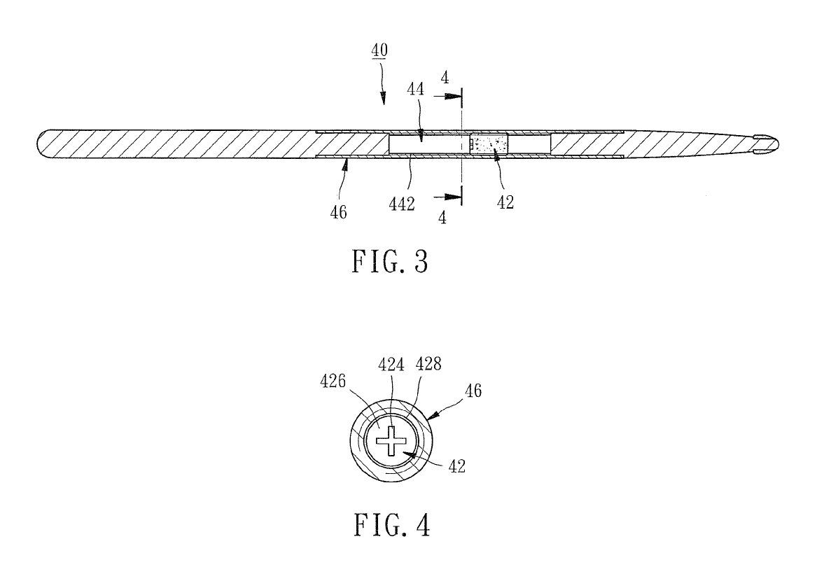

FIGS. 3 and 4, illustrate the second embodiment of the drumstick 40 according to the present invention. The drumstick 40 is similar to the drumstick 10. The difference between them is that the drumstick 40 has at least a weight 42 disposed on the receiving room 44 of the shaft section 46 of the drumstick 40. In this embodiment, the inner wall 442 of the receiving room 44 is threaded. The weight 42 has a “−” or “+” ditch 424 formed on an end surface 426 thereof and a threaded side surface 428 so that the weight 42 can be threadably engaged on the inner wall 442 of the receiving room 44 and the location thereof can be adjusted by a driver. Thus, the vibrations and balance point of the drumstick 40 is adjustable.

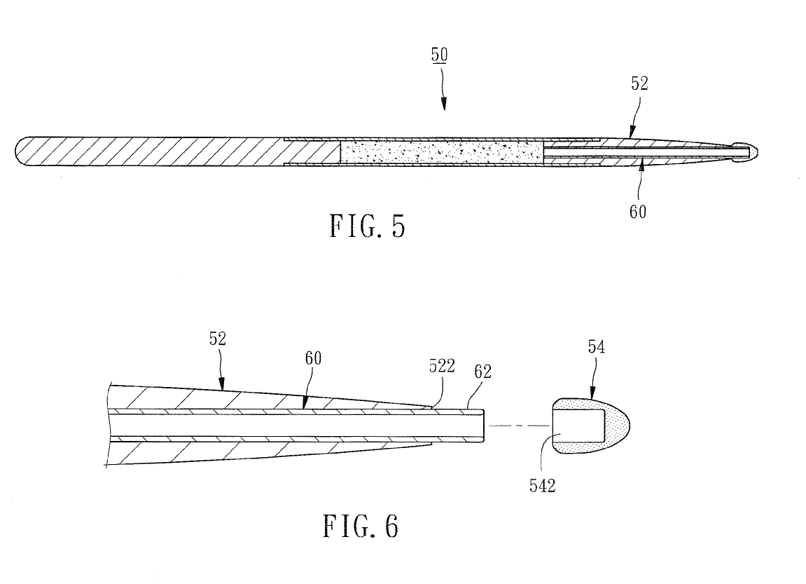

FIGS. 5 and 6 show the third embodiment of the drumstick 50 according to the present invention. The front section 52 of the drumstick 50 has a reinforced first core tube 60 embedded therein. In this embodiment, the core tube 60 is made of composite materials and has an exposed portion 62 extending from the tip end 522 of the front section 52. A striking tip 54 made of plastic materials has a cavity 62 securely inserted into by the exposed portion 62 so that the striking tip 54 can be mounted on the top end 522 of the front section of the drumstick 50.

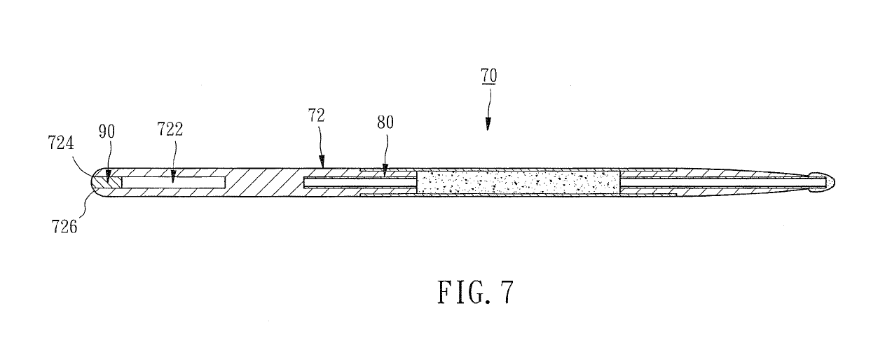

Lastly, referring to FIG. 7, it shows the fourth embodiment of the drumstick 70 according to the present invention. The drumstick 70 is generally similar to the drumstick 50 but with two differences. The one is that the handle section 72 of the drumstick 70 includes a second reinforced core tube 80 which is embedded in a front portion of the handle section 72. The second reinforced core tube 80 is also made of composite materials. The other is that the handle section 72 further includes a cylindrical aperture 722 with an opening 724 at the butt end 726 of the handle section 72. A weight 90 is adjustability positioned in the cylindrical aperture 722 so that the vibrations and balance point of the drumstick 70 can be adjustable.

What is claimed is:

1. A drumstick, comprising:
an elongated rigid body having a front section, a shaft section and a handle section;
said front section being made of wooden or bamboo materials and having a tip end, a distal end, and a body tapering from said distal end to said top end;
a tip mounted on said top end of said front section;
said handle section being made of wooden or bamboo materials and having a front end and a butt end;
said shaft section made of composite materials and having a first end jointed to said distal end of said front section, a second end jointed to said front end of said handle section; and
said shaft second further having a receiving room defined between said first and second ends for receiving a vibration-absorbing devices or weights.

2. The drumstick of claim 1, wherein said shaft section has tubular body with a first open end and a second open end; said distal end of said front section and said front end of said handle section are respectively securely inserted into said tubular body from said first open end and said second open end in such a way that said receiving room is defined therebetween.

3. The drumstick of claim 1, wherein said front section includes a first rein-forced core member made of a material having a larger rigidity than wood or bamboo.

4. The drumstick of claim 3, wherein said first rein-forced core member is a tube made of fiber-reinforced plastic materials.

5. The drumstick of claim 4, wherein said first rein-forced core member has an exposed portion extending from said tip end of said front section.

6. The drumstick of claim 5, wherein said striking tip has a cavity, said exposed portion of said core member is securely inserted into said cavity so that said striking tip can be mounted on said top end of said front section of the drumstick.

7. The drumstick of claim 1, wherein said handle section includes a second rein-forced core tube made of composite materials.

8. The drumstick of claim 7, wherein said core tube is embedded in a front portion of said handle section.

9. The drumstick of claim 8, wherein said handle section further includes a cylindrical aperture with an opening at said butt end of said handle section for receiving weights.
